(19) United States
(12) Patent Application Publication
(10) Pub. No.: US 2026/0309117 A1
(43) Pub. Date: Oct. 8, 2026

(54) WAVE ENERGY CONVERTER

(71) Applicant: BREAKING WAVE TECHNOLOGIES LTD., Vancouver (CA)

(72) Inventors: Walter Lane RUD, Delta (CA); David Stewart FRANKS, Vancouver (CA)

(21) Appl. No.: 19/482,128

(22) PCT Filed: May 11, 2023
(86) PCT No.: PCT/CA2023/050653

§ 371 Date: Nov. 6, 2025

(51) Int. Cl. F03B 13/14

(52) U.S. Cl. CPC F03B 13/14

(57) ABSTRACT

A wave energy converter is provided. The converter includes a first frame with buoyancy means, and a second frame with buoyancy means and a displaceable member. The first frame is hingedly connected to the second frame. The converter further includes a linkage assembly with a first end hingedly connected to the first frame, and a second end that is actuatingly engageable with the displaceable member. The linkage assembly is configured to translate hinged motion between the first frame and the second frame to the displaceable member. A generator may be connected to the displaceable member for generating electricity from pressure pulses from compression and extension of the displaceable member.

### TECHNICAL FIELD

This invention relates to energy generation devices, and in particular to apparatuses for generating energy from waves in fluids.

### BACKGROUND

There is a general desire to capture energy from waves.

Devices that harness the mechanical energy of water waves for useful ends (e.g. generation of electrical energy, driving desalination processes, etc.) are known. Many known devices locate their power take off systems at the water line or below it, making repairing the systems difficult and expensive. Some such known devices utilize piston cylinders which extend and compress in response to wave motion. Such cylinders may have a tendency to become corroded over time as they are exposed to ocean water and other elements in the surrounding environment, thus reducing the longevity of the pistons and the overall viability of the energy conversion device.

Further, many known devices, while efficient in energy extraction, are not well suited for open ocean use. For example, such devices may have difficulty withstanding the strong forces of water and wind during a storm in the open ocean and are thus susceptible to becoming damaged. These devices may therefore require frequent repair or replacement, thus reducing their economic efficiency. Thus many known devices are not cost effective in practical application due to their susceptibility to damage in open ocean use.

There remains a need for a wave energy conversion device which is durable, cost effective and efficient.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a wave energy converter. The wave energy converter comprises: a first frame comprising buoyancy means; a second frame comprising buoyancy means and a displaceable member, the first frame hingedly connected to the second frame; and a linkage assembly comprising a first end connected to the first frame, and a second end actuatingly engageable with the displaceable member, whereby the linkage assembly is configured to translate hinged motion between the first frame and the second frame to the displaceable member.

The first end of the linkage assembly may comprise an elongate member hingedly connected to an upper part of the first frame; and the second end of the linkage assembly may comprise a tower hingedly connected to a lower part of the second frame.

The tower may comprise an upper end and a lower end; the upper end of the tower may hingedly connected to the elongate member; and the lower end of the tower may hingedly connected to the lower part of the second frame. The lower end of the tower may hingedly connected to the lower part of the second frame at a plurality of spaced apart locations. The tower may actuatingly engage with the displaceable member at an engagement point between the upper end of the tower and the lower end of the tower, or between an approximate mid point in height of the tower and the upper end of the tower. The engagement point may be at the approximate mid point in height of the tower.

The tower may comprise a rhombus or kite cross-sectional profile, the tower comprising a quadrilateral mid section in a plane defined by a minor diagonal of the rhombus or kite cross-sectional profile, wherein the mid section comprises the engagement point. The mid section may comprise a planar truss, and a node along an approximate mid point of a side of the planar truss adjacent the displaceable member may define the engagement point. The tower may be a space frame truss.

The first frame and the second frame may be rectangular pyramidal shaped and hingedly connected along a corresponding side of their respective bases. An upper vertex may comprise the first end of the linkage assembly is hingedly connected to an upper vertex of the first frame.

The first frame and the second frame may each comprise a plurality of arms, wherein a length to width aspect ratio of the arms is at least 50, at least 100, at least 150, or at least 200.

The first frame and the second frame may each have a solidity ratio of at least 1:4, or at least 1:6, or at least 1:8, or at least 1:10, wherein the solidity ratio is defined as a total surface area of the first frame or the second frame divided by a total surface area of a volume enclosed by each the first frame or the second frame respectively.

Respective heights of the first frame, the second frame and the linkage assembly may be approximately the same.

The buoyancy means may comprise one or more of: pontoons, buoys, floats, or a body forming a hollow chamber. The buoyancy means of the first frame and the second frame may be elongated and oriented parallel with a hinge axis of the hinged connection between the first frame and the second frame.

The first frame may comprise a first elongated buoyancy means along an outer edge of a base of the first frame, and the second frame may comprise second and third elongated buoyancy means along opposing edges of a base of the second frame.

The buoyancy means of the first frame may comprise a cross-sectional profile of an isosceles trapezoid, and the buoyancy means of the second frame may comprise a cross-sectional profile of one of: a triangle, a parallelogram, or an isosceles trapezoid.

The buoyancy means may have a length to width aspect ratio of at least 5, at least 10, at least 20, or at least 30.

The displaceable member may comprise a linearly displaceable member. The linearly displaceable member may be one of: a single acting cylinder, a double acting cylinder, a tie rod cylinder, a telescopic cylinder, or a double-rod cylinder. The linearly displaceable member may be a linear generator. The generator may be connected to the linearly displaceable member for generating electrical energy from pressure pulses from compression of the linearly displaceable member.

The wave energy converter may include a desalination device connected to the generator for driving a desalination process.

The displaceable member may be pivotally connected to struts of the second frame.

The actuatable member of the displaceable member may be connected to the second end of the linkage assembly.

The wave energy converter may include a third frame comprising buoyancy means, the third frame hingedly connected to the second frame, wherein the secondary frame comprises a second displaceable member; and a second linkage assembly comprising a first end connected to the third frame, and a second end actuatingly engageable to the second displaceable member, whereby the second linkage assembly is configured to translate hinged motion between the third frame and the second frame to the second displaceable member.

The third frame may be hingedly connected to the second frame opposite to the first frame.

The first end of the second linkage assembly may comprise an elongate member hingedly connected to an upper part of the third frame; the second end of the second linkage assembly may comprise a tower hingedly connected to a lower part of the second frame. The tower may comprise an upper end and a lower end; the upper end of the tower may be hingedly connected to the elongate member; the lower end of the tower may be hingedly connected to the lower part of the second frame; wherein the lower end of the tower may be hingedly connected to the lower part of the second frame at a plurality of spaced apart locations; wherein the tower may be actuatingly engageable with the second displaceable member at an engagement point between the upper end of the tower and the lower end of the tower; wherein the engagement point may be at an approximate mid point in height between the upper end of the tower and the lower end of the tower; wherein the tower may comprise a rhombus or kite cross-sectional profile, the tower may comprise a quadrilateral mid section in a plane defined by a minor diagonal of the rhombus or kite cross-sectional profile, wherein the mid section may comprise the engagement point; wherein the mid section may comprise a planar truss, and wherein a node along an approximate mid point of a side of the planar truss adjacent the second displaceable member may define the engagement point; and wherein the tower may be a space frame truss.

The third frame and the second frame may be rectangular pyramidal shaped and hingedly connected along a corresponding side of their respective bases; wherein an upper vertex comprising the first end of the second linkage assembly may be hingedly connected to an upper vertex of the third frame; wherein the third frame and the second frame each comprise a plurality of arms, wherein a length to width aspect ratio of the arms is at least 50, at least 100, at least 150, or at least 200; wherein the third frame and the second frame each have a solidity ratio of at least 1:4, or at least 1:6, or at least 1:8, or at least 1:10, wherein the solidity ratio is defined as a total surface area of the third frame or the second frame divided by a total surface area of a volume enclosed by each the third frame or the second frame respectively; wherein respective heights of the first frame, the second frame, the third frame, the first linkage assembly, and the second linkage assembly are approximately the same.

The buoyancy means of the third frame may comprise one or more of: pontoons, buoys, floats, or a body forming a hollow chamber; wherein the buoyancy means of the third frame and the second frame may be elongated and oriented parallel with a hinge axis of the hinged connection between the third frame and the second frame; wherein the third frame may comprise a fourth elongated buoyancy means along an outer edge of a base of the third frame; wherein the buoyancy means of the third frame may comprise a cross-sectional profile of an isosceles trapezoid; wherein the fourth elongated buoyancy means has a length to width aspect ratio of at least 5, at least 10, at least 20, or at least 30.

The second displaceable member may comprise a linearly displaceable member, wherein the linearly displaceable member may be one of: a single acting cylinder, a double acting cylinder, a tie rod cylinder, a telescopic cylinder, or a double-rod cylinder, or a linear generator. A generator may be connected to the second linearly displaceable member for generating electrical energy from pressure pulses from compression of the second linearly displaceable member. A desalination device may be connected to the generator for driving a desalination process. The second displaceable member may be pivotally connected to struts of the second frame. An actuatable member of the displaceable member may be connected to the second end of the second linkage assembly.

The displaceable member may displace in a first plane; the secondary displaceable member may displace in a second plane; wherein the quadrilateral mid section of the tower of the linkage assembly may be offset from the second plane, and wherein the quadrilateral mid section of the tower of second linkage assembly may be offset from the first plane. The first plane and the second plane may be parallel to each other.

The first frame and second frame may be dimensioned for the buoyancy means of the first frame to be in a wave trough when the buoyancy means of the second frame is in a wave peak.

The first frame, the second frame and the third frame may be dimensioned for the buoyancy means of the first frame and the third frame to be in a wave trough when the buoyancy means of the second frame is in a wave peak.

The displaceable member may be lockable such that the first frame is not moveable relative to the second frame. The second displaceable member may be lockable such that the third frame is not moveable relative to the second frame.

The wave energy converter may comprise an anchor.

Another aspect provides a method of capturing energy from waves. The method comprises: displacing a first frame hingedly connected to a second frame with a wave in a fluid; displacing a linkage assembly hingedly connected to the first frame, wherein the linkage assembly is further hingedly connected to the second frame; and displacing a displaceable member with an engagement point of the linkage assembly, wherein the engagement point is between about a mid point of a height of the linkage assembly and an upper end of the linkage assembly. The method may comprise generating electricity from displacing the displaceable member. The method may comprise locking the displaceable member to stop the first frame from displacing relative to the second frame. The method may comprise selecting a base dimension of the first frame and/or the second frame to be approximately half of the wavelength of an average wave of a location and/or at a particular time. The method may be performed by a wave energy converter as described herein.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a side view of a wave energy converter with two frames according to an example embodiment.

FIG. 2 is a top view of a wave energy converter with two frames according to the embodiment shown in FIG. 1.

FIG. 3 is a perspective view of a wave energy converter with three frames according to an example embodiment.

FIG. 4 is a side view of a wave energy converter with three frames according to the embodiment shown in FIG. 3.

FIG. 5 is a top view of a wave energy converter with three frames according to the embodiment shown in FIG. 3.

FIG. 6 is a flowchart of a method for capturing energy from waves according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

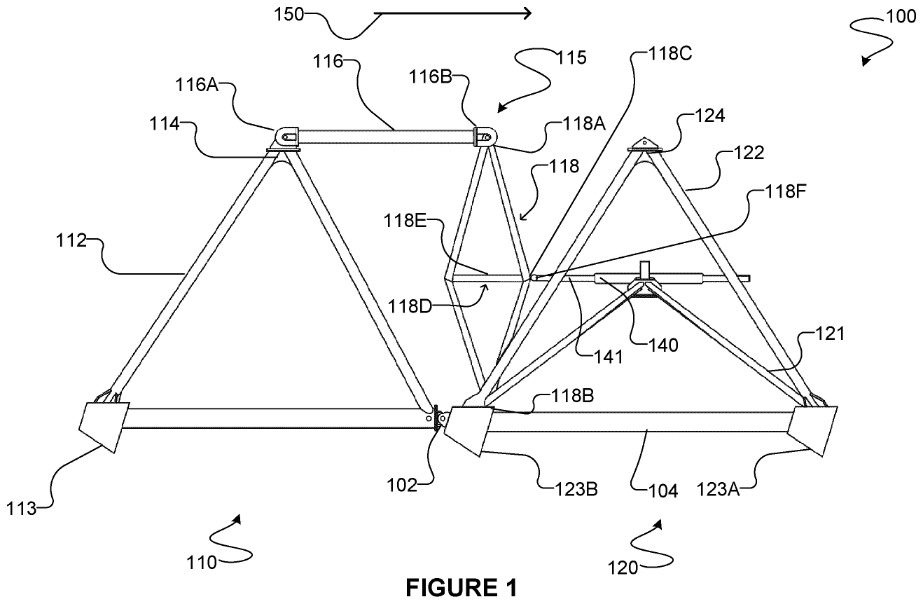

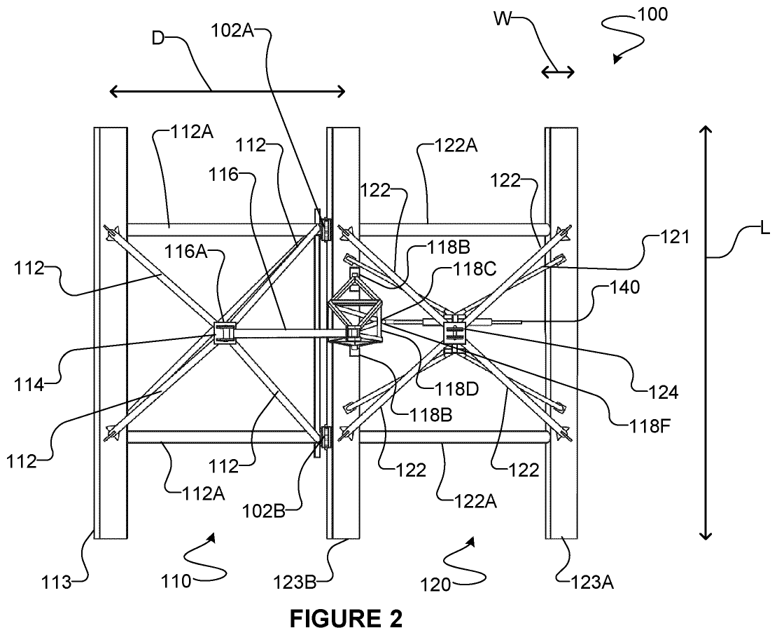

FIG. 1 is a wave energy converter 100 with two frames according to an example embodiment. A first frame 110 is hingedly connected to a second frame 120 at hinges 102A, 102B (hinges 102A and 102B are collectively identified as hinge 102 in FIG. 1, and are each individually visible in FIG. 2). In other embodiments, the connection between first frame 110 and second frame 120 may be achieved with a single hinge 102 or more than two hinges 102 at spaced apart locations (for example hinges 102A and 102B in FIG. 1).

First frame 110 has buoyancy means 113. Second frame 120 has buoyancy means 123A and 123B. Buoyancy means 113, 123A, and 123B allow first frame 110 and second frame 120 to float in a fluid.

A linkage assembly 115 has a first end 116 and second end 118. First end 116 of linkage assembly 115 is hingedly connected to first frame 110, and second end 118 of linkage assembly 115 is actuatingly engageable with displaceable member 140. Displaceable member 140 is supported in second frame 120 by struts 121. In some embodiments, displaceable member 140 is pivotally supported by struts 121. Linkage assembly 115 translates hinged motion between first frame 110 and second frame 120 to displaceable member 140, for example to actuatable member 141 of displaceable member 140. Respective heights of first frame 110, second frame 120 and linkage assembly 115 may be approximately the same.

The construction of wave energy converter 100 described above enables the conversion of wave energy to alternate forms of energy. As a wave travels through a fluid (for example in the direction represented by arrow 150 in FIG. 1), first frame 110 and second frame 120 can be displaced relative to each other. For example, first frame 110 and second frame 120 can be displaced relative to each other in a vertical plane. The displacement of first frame 110 and second frame 120 relative to each other results in displacement of linkage assembly 115. As linkage assembly 115 is displaced, displaceable member 140 is displaced. The displacement of displaceable member 140 can be used to convert energy from waves into alternate forms of energy.

In some embodiments, first end 116 of linkage assembly 115 comprises an elongate member 116. Elongate member 116 can be hingedly connected to an upper part of first frame 110, for example at connection point 116A, and hingedly connected to second end 118 at connection point 116B.

In some embodiments, second end 118 of linkage assembly 115 is a tower 118. In some embodiments tower 118 is a space frame truss. One or more lower ends or nodes of tower 118 can be hingedly connected to a lower part of second frame 120, for example at one or more connection points 118B on buoyancy means 123B.

An upper end or node of tower 118 can be hingedly connected to elongate member 116 at connection point 118A. Connection point 116B and connection point 118A may be the same in some embodiments.

Engagement point 118C of tower 118 is actuatingly engageable with displaceable member 140. Engagement point 118C is at a point between the upper and lower ends of tower. In some embodiments, engagement point 118C is between an approximate mid point in height of tower 118 and the upper end of the tower 118. In some embodiments, as shown in the Figures, engagement point 118C is at an approximate mid point in height of tower 118. In some embodiments, displaceable member 140 is hingedly connected to engagement point 118C by hinge 118F. Providing engagement point 118C, and correspondingly displaceable member 140, at between an approximate mid point in height of tower 118 and the upper end of the tower 118, or at an approximate mid point in height of tower 118, has a number of advantages. Positioning displaceable member 140 well above the base of frames 110 and 120 limits exposure of components of displaceable member 140 to water, lengthening the life of displaceable member 140. Between an approximate mid point in height of tower 118 and the upper end of the tower 118, compared to lower positions, is where relatively greater displacement as between frames 110 and 120, and therefore greater stroke length for engagement point 118C and displaceable member 140, occurs, to generate relatively greater power. In some embodiments, the approximate mid point, while having a shorter stroke length than a point at the top of the frames, is also where a more powerful stroke is generated compared to the top of the frames (e.g. by a 2:1 ratio).

In some embodiments, tower 118 may have a rhombus cross-sectional profile (as shown in the Figures) or a kite cross-sectional profile. In such embodiments, tower 118 may have a quadrilateral mid section 118D in a plane defined by a minor diagonal 118E of the rhombus or the kite cross-sectional profile. As best shown in FIG. 2, mid section 118D may be a planar truss, and a node along an approximate mid point of a side of mid section 118D adjacent displaceable member 140 may define engagement point 118C. Engagement point 118C being a node of a planar truss provides it with additional strength.

First frame 110 and second frame 120 may each comprise four arms 112 and four arms 122 respectively. Arms 112 and/or arms 122 converge at upper vertex 114 and upper vertex 124 respectively such that first frame 110 and second frame 120 are rectangular pyramidal shaped. The shape formed by first frame 110 and second frame 120 could also be referred to as a pentahedron.

As described above, first frame 110 and second frame 120 are “open”—that is, first frame 110 and second frame 120 are mostly empty space. Buoyancy means 123A and 123B, arms 122, and upper vertex 124 may have substantially no material in between them. Similarly, buoyancy means 113, arms 112, and upper vertex 114 may have substantially no material in between them.

In some embodiments, arms 112 and arms 122 may each have a length to width aspect ratio of at least 50, at least 100, at least 150, or at least 200.

In some embodiments, the “open”-ness of first frame 110 and second frame 120 is defined by a solidity ratio, defined as the total surface area of each frame divided by the total surface area of the volume enclosed by each frame. For example, for second frame 120, the total surface area would be the sum of the surface area of buoyancy means 123A and 123B, struts 121, arms 122, base members 122A, and displaceable member 140. The total surface area of the volume enclosed by second frame 120 would be the four triangular side ‘windows’ and one rectangular bottom ‘window’ defining the rectangular pyramidal shape of second frame 120. In some embodiments, the solidity ratio of first frame 110 and second frame 120 is at least 1:4, or at least 1:6, or at least 1:8, or at least 1:10.

The foregoing features and characteristics of first frame 110 and second frame 120 improves the durability of wave energy converter 100 during storms. Large waves which occur during storms at sea, for example, may mostly ‘pass through’ first frame 110 and second frame 120. Allowing waves to pass through first frame 110 and second frame 120 effectively limits the amount of mechanical energy displaceable member 140 can capture from any given wave, thereby limiting overloading of wave energy converter 100 in exigent conditions. The foregoing characteristics and features of first frame 110 and second frame 120 also reduce the overall weight of wave energy converter 100.

In some embodiments, elongate member 116 may be hingedly connected to upper vertex 114 of first frame 110 at connection point 116A.

In some embodiments, to improve the durability of wave energy converter 100 in exigent conditions, displaceable member 140 is lockable. When displaceable member 140 is locked, displaceable member 140 cannot be displaced by linkage assembly 115. Locking displaceable member 140 ensures that wave energy converter 100 is not overloaded to the point of failure in exigent conditions. Locking displaceable member 140 also improves the resiliency of wave energy converter 100 in exigent conditions, as rigid structures tend to be less susceptible to damage from waves.

Buoyancy means 113, 123A and 123B allow wave energy converter 100 to float. Buoyancy means 113, 123A and 123B may each comprise a single elongate body, as shown in FIG. 2. Buoyancy means 113, 123A and 123B may comprise one or more of: pontoons, buoys, floats, or a body forming a hollow chamber.

In some embodiments, buoyancy means 123A and buoyancy means 123B may have a cross sectional shape of an isosceles trapezoid, as shown in the example embodiment in FIG. 1.

In some embodiments, buoyancy means 113 may have a cross sectional shape of one of: a triangle, a parallelogram, or an isosceles trapezoid.

In some embodiments, buoyancy means 113, 123A and 123B may have a length defined by arrow L, and a width defined by arrow W. In some embodiments, a length to width aspect ratio of buoyancy means 113, 123A and 123B may be defined by the length divided by the width, and may be at least 5, at least 10, at least 20, or at least 30. Buoyancy means 113, 123A and 123B, as visible in the example embodiment of FIG. 2, may be referred to as elongated buoyancy means due to their elongate shape.

In some embodiments, such as shown in the Figures, buoyancy means 113, 123A and 123B are elongated and are oriented parallel with a hinge axis of the hinged connection between first frame 110 and second frame 120. In some embodiments, buoyancy means 113 is connected to an outer edge of a base of first frame 110, and buoyancy means 123A and 123B are connected along opposing edges of a base of second frame 120.

In some embodiments, displaceable member 140 comprises a linearly displaceable member. The linearly displaceable member could be one of: a single acting cylinder, a double acting cylinder, a tie rod cylinder, a telescopic cylinder, or a double-rod cylinder. Any one of the aforementioned displaceable members could, for example, be a hydraulic cylinder. In some embodiments, the linearly displaceable member could be a linear generator.

As first frame 110 and second frame 120 displace relative to each other, it may be desirable to generate electrical energy from the displacement of displaceable member 140 (which could be a linearly displaceable member in some embodiments, as mentioned earlier). Consequently, in some embodiments an electrical generator is operably connected to displaceable member 140. The electrical generator could be capable of generating electrical energy from pressure pulses from compression of linearly displaceable member 140 by linkage assembly 115.

Large waves, which are desirable for wave energy capture as they contain a large amount of energy, can often be found in the ocean. Water from the ocean often has a high salt content. Consequently, it may be desirable to desalinate ocean water using wave energy converter 100. As such, in some embodiments, wave energy converter 100 may include or be associated with a desalination device operably connected to displaceable member 140.

As mentioned above, wave energy converter 100 may be used in oceans. Consequently in some embodiments, wave energy converter 100 can have an anchor. By way of example, anchor point 104 (visible in FIG. 1) could be used to affix an anchor to wave energy converter 100.

When in a fluid with a wave, the maximum displacement of first frame 110 relative to second frame 120 occurs when buoyancy means 113 is in a wave trough and buoyancy means 123B is in a wave peak (or vice versa, i.e. when buoyancy means 123B is in a wave trough and buoyancy means 113 is in a wave peak). Achieving maximum displacement of first frame 110 relative to second frame 120 is desirable as it maximizes the amount that displaceable member 140 can be displaced by, thereby increasing the amount of energy that can be captured from a wave.

Waves in many locations have an average wavelength. As such, it is possible to select the size of wave energy converter 100 for a particular location such that, in an average wave, buoyancy means 113 is in a wave peak (or trough) when buoyancy means 123B is in a wave trough (or peak) respectively. Dimension D of wave energy converter 100 can be selected so that it is half of the wavelength of an average wave in a particular location and/or at a particular time to attempt to maximize the amount of energy recoverable with wave energy converter 100. Dimension D is approximately the span from one buoyancy means to an adjacent buoyancy means in wave energy converter 100 or 200. In some embodiments wherein frames of the wave energy converter are all similarly sized square pyramids, dimension D is also approximately the length of one side of the base of the pyramid. Dimension D can optionally be referred to as a base dimension.

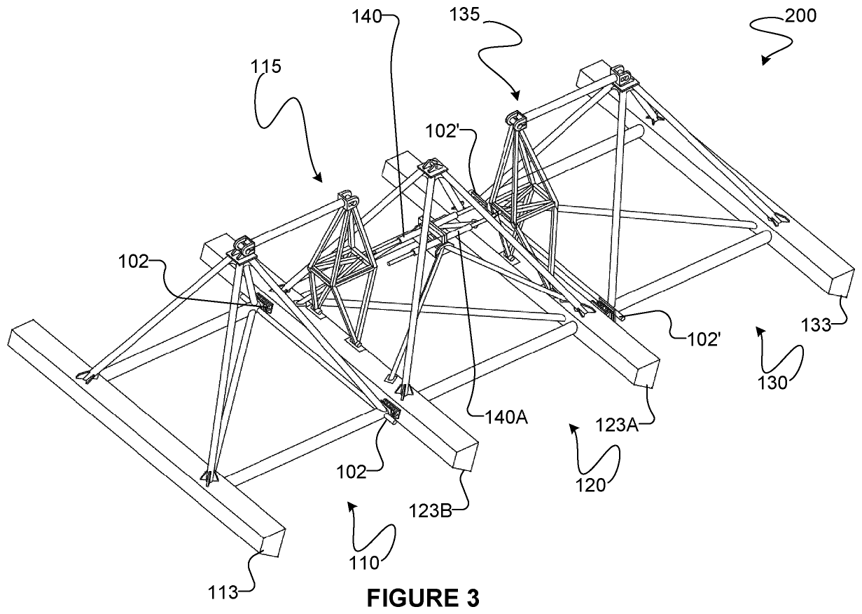

FIG. 3 is a perspective view of wave energy converter 200 with three frames according to an example embodiment. Unless the context dictates otherwise, those elements of wave energy converter 100 that are identified by references also used to identify elements of wave energy converter 200 have the same or similar features and/or functions as described with respect to wave energy converter 100.

Wave energy converter 200 is similar in features and functions to wave energy converter 100, except wave energy converter 200 comprises a third frame 130 hingedly connected to first frame 110 at hinge 102′. Wave energy converter 200 contains a second displaceable member 140A within second frame 120.

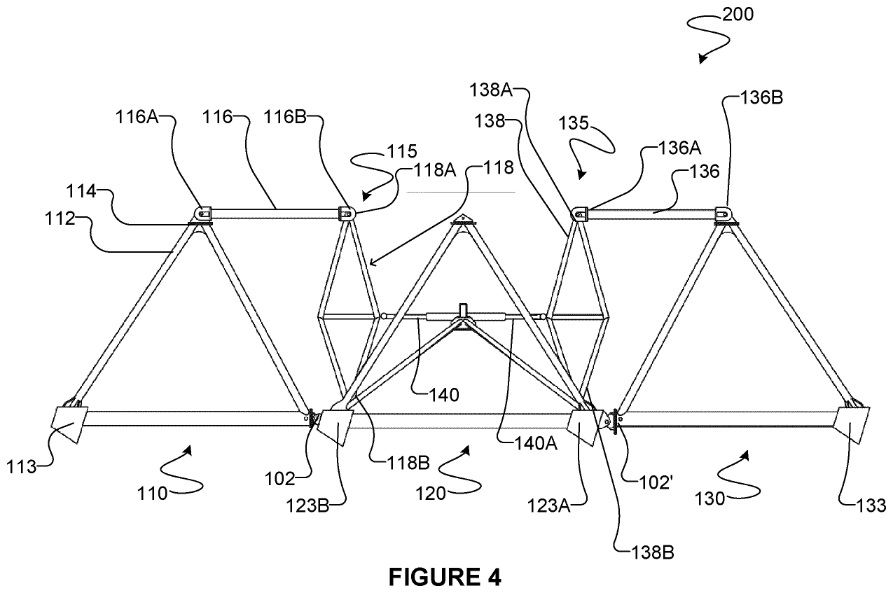

FIG. 4 is a side view of wave energy converter 200. Third frame 130 comprises buoyancy means 133 that allows third frame 130 to float. Third frame 130 has a linkage assembly 135, which comprises first end 136 hingedly connected to third frame 130, and second end 138 actuatingly engageble with displaceable member 140A. Second end 138 may also be referred to as tower 138.

Third frame 130 has similar functions and features to first frame 110. As first frame 110 or third frame 130 are displaced relative to second frame 120, linkage assembly 115 or 135 respectively are displaced. Displacement of linkage assembly 115 or 135 displaces displaceable member 140 or displaceable member 140A respectively.

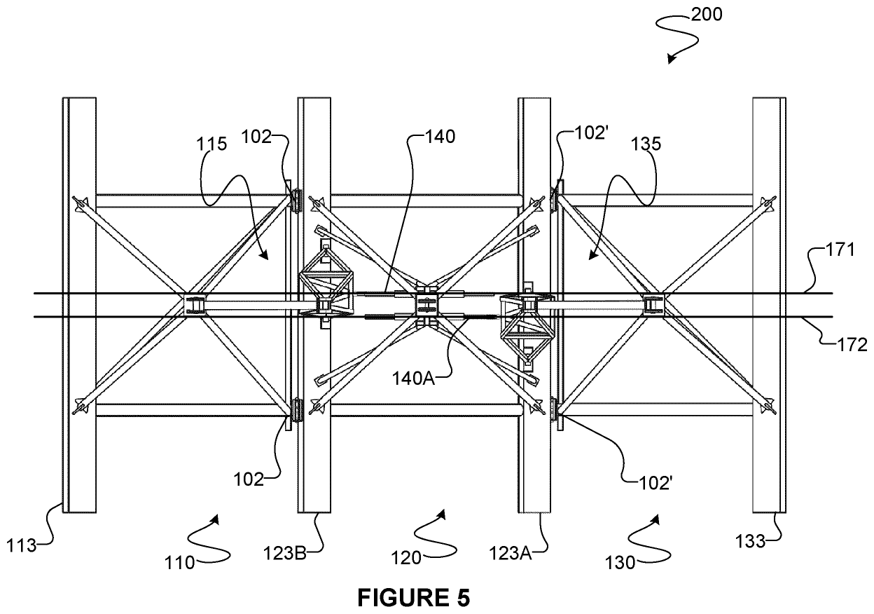

FIG. 5 is a top view of wave energy converter 200. As visible in FIG. 5, second frame 120 comprises displaceable member 140 and displaceable member 140A.

Conditions in typical operating locations for wave energy capture devices are demanding. As such, when wave energy converter 200 is in use, it may be desirable to ensure that the system has redundancies in place to ensure that wave energy converter 200 is still able to generate energy if a portion of wave energy converter 200 malfunctions. Furthermore, under normal operation it may be desirable to generate energy from displacing more than one displaceable member, as this may be able to increase energy output. Consequently, as visible in FIG. 5, wave energy converter 200 has two independent displaceable members (displaceable member 140 and secondary displaceable member 140A).

In operation, as first frame 110 displaces relative to second frame 120, linkage assembly 115 is displaced. Displacement of linkage assembly 115 results in displaceable member 140 displacing in the plane containing line 171. Tower 138 in second frame 120 is offset from the plane containing line 171 to avoid interfering with the stroke of displaceable member 140.

As third frame 130 displaces relative to second frame 120, linkage assembly 135 is displaced. Displacement of linkage assembly 135 results in secondary displaceable member 140A displacing in the plane containing line 172. Tower 118 of first frame 110 is offset from the plane containing line 172 to avoid interfering with the stroke of displaceable member 140A.

The plane containing line 171 and the plane containing line 172 are parallel to each other (and therefore do not intersect). Displaceable member 140 and displaceable member 140A are therefore independently displaceable by linkage assembly 115 and linkage assembly 135 respectively. This improves the resiliency of wave energy converter 200. If displaceable member 140A were to malfunction during operation, then energy could still be captured through the use of displaceable member 140, and vice versa.

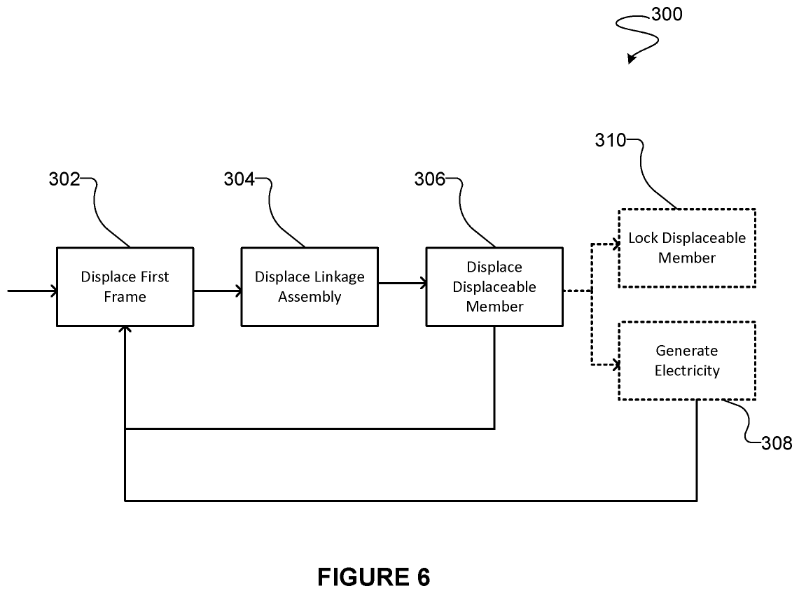

FIG. 6 is a flowchart of a method 300 of capturing energy from waves according to an example embodiment. In some embodiments method 300 may be practiced with wave energy converter 100 or 200 and the like.

Step 302 comprises displacing a first frame (for example, first frame 110) hingedly connected to a second frame (for example, second frame 120).

Step 304 comprises displacing a linkage assembly (for example, linkage assembly 115) hingedly connected to both the first frame and the second frame.

Step 306 comprises displacing a displaceable member with the linkage assembly. In some embodiments the engagement of the displaceable member with the linkage assembly occurs at an engagement point between approximately a mid point in height of the linkage assembly and an upper end of the linkage assembly.

At step 306, method 300 can return to step 302 and repeat.

Optionally, step 308 entails generating electricity. Electricity can be generated from compression and extension of the displaceable member. At step 308, method 300 can return to step 302 and repeat.

Optionally, step 310 further comprises locking the displaceable member. As mentioned earlier, it may be desirable to lock the displaceable member in exigent conditions to avoid overloading the wave energy converter, or protect the wave energy converter from damage. If step 310 is reached, then method 300 ends.

Optionally, before step 302, as described above, dimension D of a wave energy converter such as wave energy converter 100 or 200 can be selected so that it is approximately half of the wavelength of an average wave in a particular location and/or at a particular time.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A wave energy converter comprising:
a first frame comprising buoyancy means;
a second frame comprising buoyancy means and a displaceable member, the first frame hingedly connected to the second frame; and
a linkage assembly comprising a first end connected to the first frame, and a second end actuatingly engageable with the displaceable member, whereby the linkage assembly is configured to translate hinged motion between the first frame and the second frame to the displaceable member.

2. The wave energy converter of claim 1 wherein:
the first end of the linkage assembly comprises an elongate member hingedly connected to an upper part of the first frame; and
the second end of the linkage assembly comprises a tower hingedly connected to a lower part of the second frame.

3. The wave energy converter of claim 2 wherein:
the tower comprises an upper end and a lower end;
the upper end of the tower is hingedly connected to the elongate member; and
the lower end of the tower is hingedly connected to the lower part of the second frame.

4. The wave energy converter of claim 3 wherein the lower end of the tower is hingedly connected to the lower part of the second frame at a plurality of spaced apart locations.

5. The wave energy converter of claim 4 wherein the tower is actuatingly engageable with the displaceable member at an engagement point between the upper end of the tower and the lower end of the tower, or between an approximate mid point in height of the tower and the upper end of the tower.

6. The wave energy converter of claim 5 wherein the engagement point is at the approximate mid point in height of the tower.

7. The wave energy converter of claim 6 wherein the tower comprises a rhombus or kite cross-sectional profile, the tower comprising a quadrilateral mid section in a plane defined by a minor diagonal of the rhombus or kite cross-sectional profile, wherein the mid section comprises the engagement point.

8. The wave energy converter of claim 7 wherein the mid section comprises a planar truss, and wherein a node along an approximate mid point of a side of the planar truss adjacent the displaceable member defines the engagement point.

9. (canceled)

10. The wave energy converter of claim 8 wherein the first frame and the second frame are rectangular pyramidal shaped and hingedly connected along a corresponding side of their respective bases.

11-15. (canceled)

16. The wave energy converter of claim 10 wherein the buoyancy means of the first frame and the second frame are elongated and oriented parallel with a hinge axis of the hinged connection between the first frame and the second frame.

17. The wave energy converter of claim 16 wherein the first frame comprises a first elongated buoyancy means along an outer edge of a base of the first frame, and the second frame comprises second and third elongated buoyancy means along opposing edges of a base of the second frame.

18. (canceled)

19. (canceled)

20. The wave energy converter of claim 17 wherein the displaceable member comprises a linearly displaceable member.

21. (canceled)

22. The wave energy converter of claim 20 wherein the linearly displaceable member is a linear generator.

23-26. (canceled)

27. The wave energy converter of claim 1 further comprising:
a third frame comprising buoyancy means, the third frame hingedly connected to the second frame, wherein the secondary frame comprises a second displaceable member; and
a second linkage assembly comprising a first end connected to the third frame, and a second end actuatingly engageable to the second displaceable member, whereby the second linkage assembly is configured to translate hinged motion between the third frame and the second frame to the second displaceable member.

28. The wave energy converter of claim 27 wherein the third frame is hingedly connected to the second frame opposite to the first frame.

29. The wave energy converter of claim 28 wherein the first end of the second linkage assembly comprises an elongate member hingedly connected to an upper part of the third frame;
the second end of the second linkage assembly comprises a tower hingedly connected to a lower part of the second frame;
wherein the tower comprises an upper end and a lower end;
the upper end of the tower is hingedly connected to the elongate member;
the lower end of the tower is hingedly connected to the lower part of the second frame;
wherein the lower end of the tower is hingedly connected to the lower part of the second frame at a plurality of spaced apart locations;
wherein the tower is actuatingly engageable with the second displaceable member at an engagement point between the upper end of the tower and the lower end of the tower;
wherein the engagement point is at an approximate mid point in height between the upper end of the tower and the lower end of the tower;
wherein the tower comprises a rhombus or kite cross-sectional profile, the tower comprising a quadrilateral mid section in a plane defined by a minor diagonal of the rhombus or kite cross-sectional profile, wherein the mid section comprises the engagement point;
wherein the mid section comprises a planar truss, and wherein a node along an approximate mid point of a side of the planar truss adjacent the second displaceable member defines the engagement point; and
wherein the tower is a space frame truss.

30-43. (canceled)

44. A method of capturing energy from waves comprising:
displacing a first frame hingedly connected to a second frame with a wave in a fluid;
displacing a linkage assembly hingedly connected to the first frame, wherein the linkage assembly is further hingedly connected to the second frame; and
displacing a displaceable member with an engagement point of the linkage assembly, wherein the engagement point is between about a mid point of a height of the linkage assembly and an upper end of the linkage assembly.

45. The method of claim 44 further comprising generating electricity from displacing the displaceable member.

46. The method of claim 44 further comprising locking the displaceable member to stop the first frame from displacing relative to the second frame.

47. The method of claim 44 further comprising selecting a base dimension of the first frame and/or the second frame to be approximately half of the wavelength of an average wave of a location and/or at a particular time.

48-50. (canceled)
